(19) United States
(12) Patent Application Publication
(10) Pub. No.: US 2024/0210558 A1
(43) Pub. Date: Jun. 27, 2024

(54) ULTRASOUND DEVICE AND ULTRASOUND SYSTEM INCLUDING THE SAME

(71) Applicant: HANSONO CO., LTD., Seoul (KR)

(72) Inventors: Jin Hyun KIM, Siheung-si (KR); Sang Bum KYE, Seoul (KR); Min KIM, Seoul (KR); Jae Hyuk PARK, Seoul (KR); Sun Mi YEO, Anyang-si (KR); Chang Hyeon LIM, Seoul (KR)

(73) Assignee: HANSONO CO., LTD., Seoul (KR)

(21) Appl. No.: 17/918,554

(22) PCT Filed: Mar. 11, 2022
(86) PCT No.: PCT/KR2022/003407

§ 371 Date: Oct. 12, 2022

(30) Foreign Application Priority Data
Jun. 9, 2021 (KR) 10-2021-0074646

(51) Int. Cl. G01S 15/89; G01S 7/521

(52) U.S. Cl. CPC G01S 15/89; G01S 7/521

(57) ABSTRACT

Provided is an ultrasound device including a controller and an ultrasound transceiver. The controller may classify a plurality of elements included in an ultrasound array into a plurality of sector elements, provide a transmission control signal for selecting one of the plurality of sector elements as a transmission sector, and provide a reception control signal for selecting one of the plurality of sector elements as a reception sector. The ultrasound transceiver may transmit a transmission ultrasound signal to an object by selecting the transmission sector from the plurality of sector elements included in the ultrasound array based on the transmission control signal, and receiving a reception ultrasound signal reflected from the object by selecting the reception sector from the plurality of sector elements based on the reception control signal.

The ultrasound device according to the present disclosure may have an improved image quality by transmitting the transmission ultrasound signal to the object by selecting the transmission sector from the plurality of sector elements included in the ultrasound array based on the transmission control signal, receiving the reception ultrasound signal reflected from the object by selecting the reception sector from the plurality of sector elements based on a reception control signal, and then synthesizing an ultrasound image.

### TECHNICAL FIELD

The present disclosure relates to an ultrasound device and an ultrasound system including the same.

### BACKGROUND ART

A small ultrasound device may have easy portability while having an image quality inferior to that of a large ultrasound device. Various studies are being recently conducted to improve the image quality of the small ultrasound device.

### DISCLOSURE

### Technical Problem

An object of the present disclosure is to provide an ultrasound device which may have an improved image quality by transmitting a transmission ultrasound signal to an object by selecting a transmission sector from a plurality of sector elements included in an ultrasound array based on a transmission control signal, receiving a reception ultrasound signal reflected from the object by selecting a reception sector from the plurality of sector elements based on a reception control signal, and then synthesizing an ultrasound image.

### Technical Solution

According to an embodiment of the present disclosure, an ultrasound device includes a controller and an ultrasound transceiver. The controller may classify a plurality of elements included in an ultrasound array into a plurality of sector elements, provide a transmission control signal for selecting one of the plurality of sector elements as a transmission sector, and provide a reception control signal for selecting one of the plurality of sector elements as a reception sector. The ultrasound transceiver may transmit a transmission ultrasound signal to an object by selecting the transmission sector from the plurality of sector elements included in the ultrasound array based on the transmission control signal, and receive a reception ultrasound signal reflected from the object by selecting the reception sector from the plurality of sector elements based on the reception control signal.

In an embodiment, the reception sector selected based on the reception control signal may remain the same while the transmission sector selected by ultrasound transmission/reception control is changed and the transmission ultrasound signal is transmitted N times in case that the number of the plurality of transmission sector elements is N (here, N is a natural number greater than or equal to two).

In an embodiment, the reception sector selected based on the reception control signal may be sequentially changed whenever the ultrasound transceiver transmits the transmission ultrasound signal by using the transmission sector selected based on the transmission control signal.

In an embodiment, the controller may allow the transmission sector to be changed based on the transmission control signal after the ultrasound transceiver transmits the transmission ultrasound signal consecutively N times by using the transmission sector selected by the transmission control signal.

In an embodiment, the transmission ultrasound signal may be transmitted consecutively N times by using the changed sector element corresponding to the changed transmission sector.

In an embodiment, the reception sector selected based on the reception control signal may be sequentially changed whenever the ultrasound transmits the transceiver transmission ultrasound signal by using the changed transmission sector.

In an embodiment, a plane wave is formed based on the transmission ultrasound signal provided from the ultrasound transceiver.

In an embodiment, the number of transmission sector and the number of reception sector, included in the ultrasound transceiver, may be the same as each other.

In an embodiment, the ultrasound device transmits the transmission ultrasound signal while changing an angle of the plane wave.

In an embodiment, the ultrasound device forms an ultrasound image by synthesizing the reception ultrasound signal received through the reception sector.

According to another embodiment of the present disclosure, an ultrasound system includes a controller, an ultrasound transceiver and a display. The controller may classify a plurality of elements included in an ultrasound array into a plurality of sector elements, allow a transmission control signal for selecting one of the plurality of sector elements as a transmission sector to be provided, and allow a reception control signal for selecting one of the plurality of sector elements as a reception sector to be provided. The ultrasound transceiver may select the transmission sector from the plurality of sector elements included in the ultrasound array based on the transmission control signal to transmit a transmission ultrasound signal to an object, and select the reception sector from the plurality of sector elements based on the reception control signal to receive a reception ultrasound signal reflected from the object. The display may provide an ultrasound image based on the reception ultrasound signal.

In addition to the above-mentioned technical tasks of the present disclosure, other features and advantages of the present disclosure may be described below, or may be clearly understood by those skilled in the art to which the present disclosure pertains from such description and explanation.

### DESCRIPTION OF DRAWINGS

FIG. 1 is a view showing an ultrasound device according to embodiments of the present disclosure.

FIGS. 2 to 7 are views for explaining an operation example of an ultrasound transceiver included in the ultrasound device of FIG. 1.

FIG. 8 is a view for explaining another operation example of the ultrasound transceiver included in the ultrasound device of FIG. 1.

FIG. 9 is a view for explaining a plane wave formed by the ultrasound transceiver included in the ultrasound device of FIG. 1.

FIG. 10 is a view for explaining an ultrasound image generated based on a reception ultrasound signal received by an ultrasound transceiver included in the ultrasound device of FIG. 1.

FIG. 11 is a view showing an ultrasound system according to embodiments of the present disclosure.

FIG. 12 is a view for explaining sector elements included in the ultrasound device of FIG. 1.

### [Best Mode]

In the specification, in adding reference numerals to components throughout the drawings, it is to be noted that like reference numerals designate like components even though components are shown in different drawings.

Meanwhile, meanings of terms described in this specification should be understood as follows.

Terms of singular forms used herein are intended to include their plural forms unless explicitly indicated otherwise, and a scope of the present disclosure is not limited by the terms used herein.

It is to be understood that a term “include” or “have” does not preclude the presence or addition of one or more other features, numerals, operations, components, parts or combinations thereof, which is mentioned in the specification.

Hereinafter, embodiments of the present disclosure are described in detail with reference to the accompanying drawings.

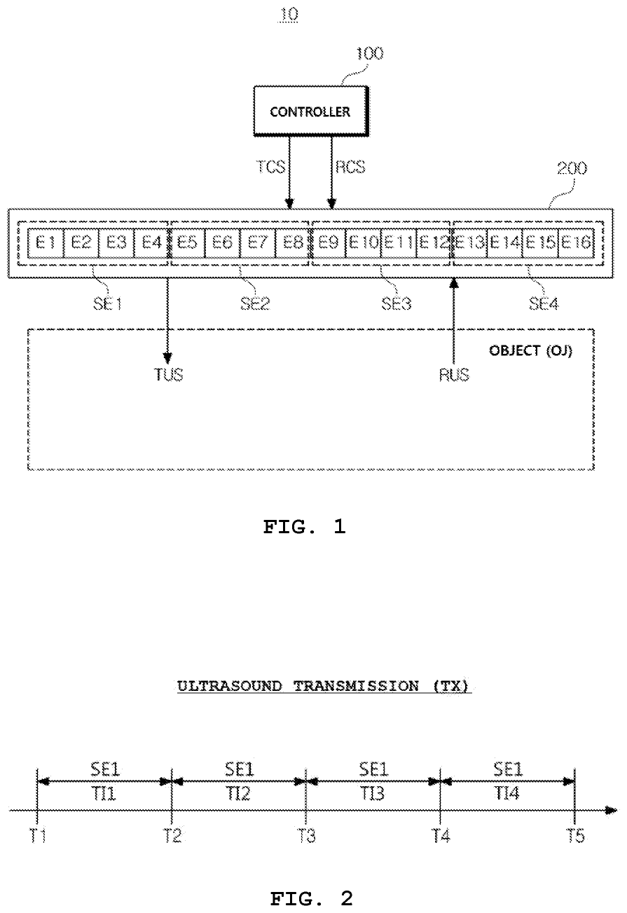

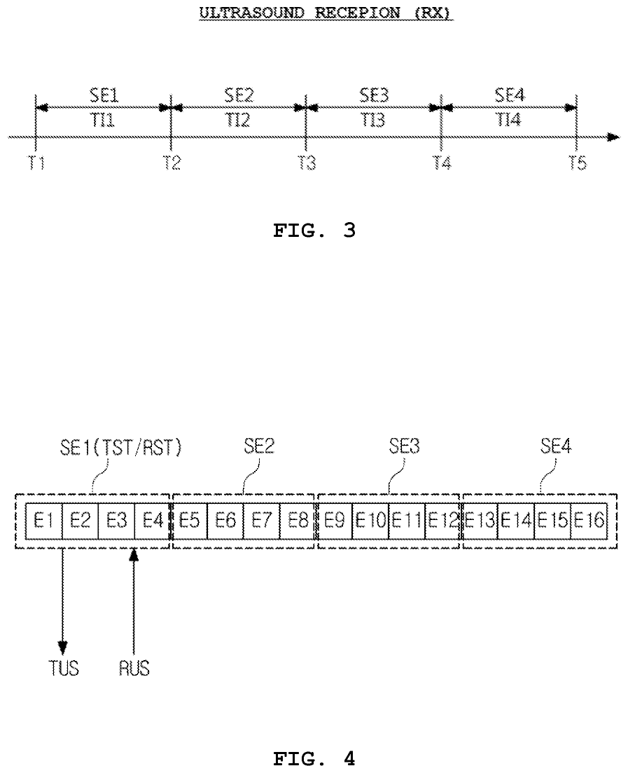

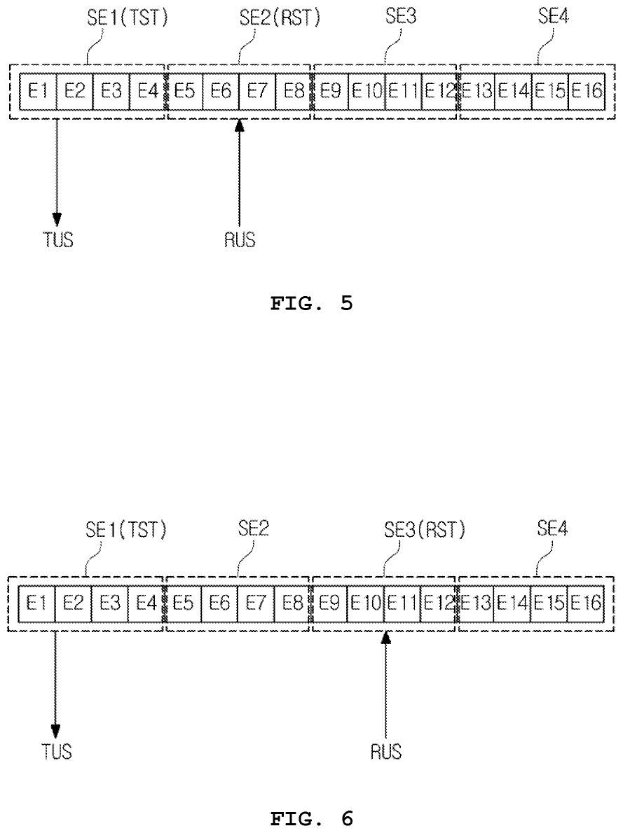

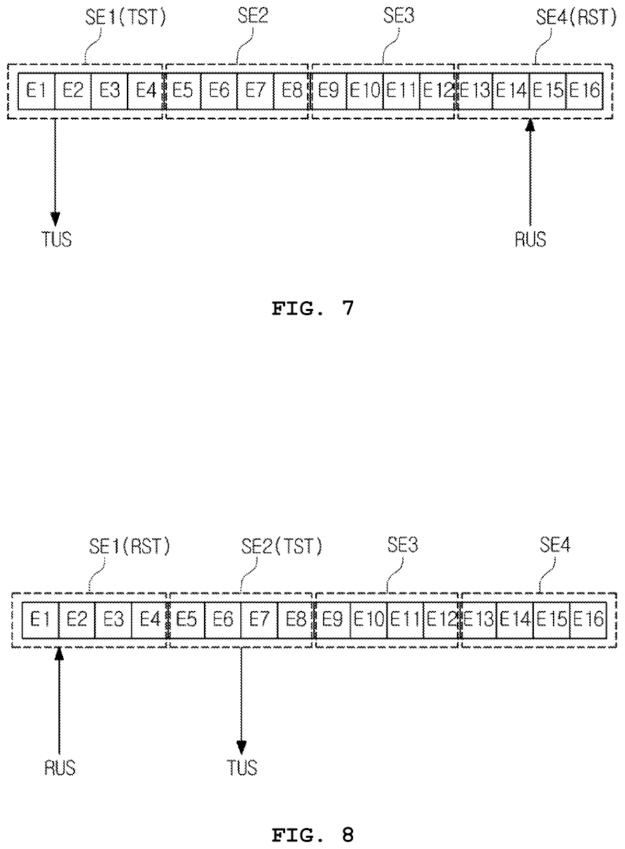

FIG. 1 is a view showing an ultrasound device according to embodiments of the present disclosure; FIGS. 2 to 7 are views for explaining an operation example of an ultrasound transceiver included in the ultrasound device of FIG. 1; and FIG. 12 is a view for explaining sector elements included in the ultrasound device of FIG. 1.

Referring to FIGS. 1 to 7 and 12, an ultrasound device 10 according to the present disclosure may include a controller 100 and an ultrasound transceiver 200. A plurality of elements included in an ultrasound array may be classified into a plurality of sector elements. For example, the plurality of elements included in the ultrasound array may include a first element El to a sixteenth element E16, and the plurality of sector elements may include a first sector element SE1 and a second sector element SE2, a third sector element SE3 and a fourth sector element SE4. The first sector element SE1 may include the first element El to the fourth element E4, and the second sector element SE2 may include the fifth element E5 to the eighth element E8. In addition, the third sector element SE3 may include the ninth element E9 to the twelfth element E12, and the fourth sector element SE4 may include the thirteenth element E13 to the sixteenth element E16.

Here, the plurality of elements is disclosed as 16 elements, and each of the sector elements is classified into 4 elements. However, the plurality of elements included in the ultrasound device 10 according to the present disclosure may be 64 elements and one hundred twenty-eight elements, or may be more elements, and each of the sector elements may be classified into four or more elements. In addition, each of the sector elements may be non-consecutive elements.

In addition, the plurality of sector elements may include transmission sector elements and reception sector elements. In this case, a configuration of the elements included in the transmission sector element may be different from a configuration of the elements included in the reception sector element.

In addition, the number of elements included in a transmission sector (TST) and the number of elements included in a reception sector (RST) may be different from each other. For example, the plurality of elements may be one hundred twenty-eight elements. The transmission sector (TST) may include two sectors, and the reception sector (RST) may include four sectors. In this case, the number of elements included in one transmission sector (TST) may be sixty-four, and the number of elements included in one reception sector (RST) may be sixteen. Here, the number of transmission sector (TST) may be N (here, N is a natural number greater than or equal to two), and the number of reception sector (RST) may be M (here, M is a natural number greater than or equal to one).

In an embodiment, each of the sector elements may be a predetermined element selected from the plurality of elements. For example, the first sector element SE1 may include a first element El, a third element E3, a fifth element E5 and a seventh element E7 with one element spacing. In this case, the selected elements may be the first element El, the third element E3, the fifth element E5 and the seventh element E7. In addition, the sector elements may be configured in various ways based on a user selection.

The controller 100 may provide a transmission control signal TCS for selecting one of the plurality of sector elements as the transmission sector TST. For example, the controller 100 may allow one of the first sector element SE1 to the fourth sector element SE4 to be selected as the transmission sector TST based on the transmission control signal TCS.

The ultrasound transceiver 200 may select the transmission sector TST from the plurality of sector elements included in the ultrasound array based on the transmission control signal TCS and transmit a transmission ultrasound signal TUS to an object OJ.

In an embodiment, the ultrasound transceiver 200 may use the transmission sector TST selected based on the transmission control signal TCS to transmit the transmission ultrasound signal TUS consecutively N times in case that the number of the plurality of sector elements is N (here, N is a natural number greater than or equal to two). For example, the transmission sector TST selected based on the transmission control signal TCS may be the first sector element SE1, and the number of the plurality of sector elements may be four. In this case, the ultrasound transceiver 200 may transmit the transmission ultrasound signal TUS to the object OJ through the first sector element SE1 four times.

The controller 100 may provide a reception control signal RCS for selecting one of the plurality of sector elements as a reception sector RST. For example, the controller 100 may allow one of the first sector element SE1 to the fourth sector element SE4 to be selected as the reception sector RST based on the reception control signal RCS.

The ultrasound transceiver 200 may select the reception sector RST from the plurality of sector elements included in the ultrasound array based on the reception control signal RCS and then receive a reception ultrasound signal RUS reflected from the object OJ.

In an embodiment, the reception sector RST selected based on the reception control signal RCS may be sequentially changed whenever the ultrasound transceiver 200 transmits the transmission ultrasound signal TUS by using the transmission sector TST selected based on the transmission control signal TCS. For example, a plurality of times may include a first time T1 to a fifth time T5, and a first time interval TIL may be a time interval from the first time T1 to the second time T2, and a second time interval TI2 may be a time interval from the second time T2 to the third time T3. In addition, a third time interval TI3 may be a time interval from the third time T3 to the fourth time T4, and a fourth time interval TI4 may be a time interval from the fourth time T4 to the fifth time T5.

For example, the transmission sector TST selected based on the transmission control signal TCS may be the first sector element SE1, and the number of the plurality of sector elements may be four. In this case, the reception sector RST selected based on the reception control signal RCS during the first time interval TIL may be the first sector element SE1. At the first time T1, the ultrasound device 10 according to the present disclosure may transmit the transmission ultrasound signal TUS to the object OJ by using the first sector element SE1, and receive the reception ultrasound signal RUS reflected from the object OJ by using the first sector element SE1. The reception sector RST selected based on the reception control signal RCS during the second time interval TI2 after the second time T2 may be the second sector element SE2. At the second time T2, the ultrasound device 10 according to the present disclosure may transmit the transmission ultrasound signal TUS to the object OJ by using the first sector element SE1, and receive the reception ultrasound signal RUS reflected from the object OJ by using the second sector element SE2. In addition, the reception sector RST selected based on the reception control signal RCS during the third time interval TI3 after the third time T3 may be the third sector element SE3. At the third time T3, the ultrasound device 10 according to the present disclosure may transmit the transmission ultrasound signal TUS to the object OJ by using the first sector element SE1, and receive the reception ultrasound signal RUS reflected from the object OJ by using the third sector element SE3. The reception sector RST selected based on the reception control signal RCS during the fourth time interval TI4 after the fourth time T4 may be the fourth sector element SE4. At the fourth time T4, the ultrasound device 10 according to the present disclosure may transmit the transmission ultrasound signal TUS to the object OJ by using the first sector element SE1, and receive the reception ultrasound signal RUS reflected from the object OJ by using the fourth sector element SE4.

In this way, the reception sector RST selected based on the reception control signal RCS may be sequentially changed from the first sector element SE1 to the fourth sector element SE4 whenever the ultrasound transceiver 200 transmits the transmission ultrasound signal TUS by using the transmission sector TST selected based on the transmission control signal TCS.

The ultrasound device 10 according to the present disclosure may have an improved image quality by selecting the transmission sector TST from the plurality of sector elements included in the ultrasound array based on the transmission control signal TCS to transmit the transmission ultrasound signal TUS to the object OJ, and by selecting the reception sector RST from the plurality of sector elements based on the reception control signal RCS to receive the reception ultrasound signal RUS reflected from the object OJ and then synthesizing an ultrasound image UI.

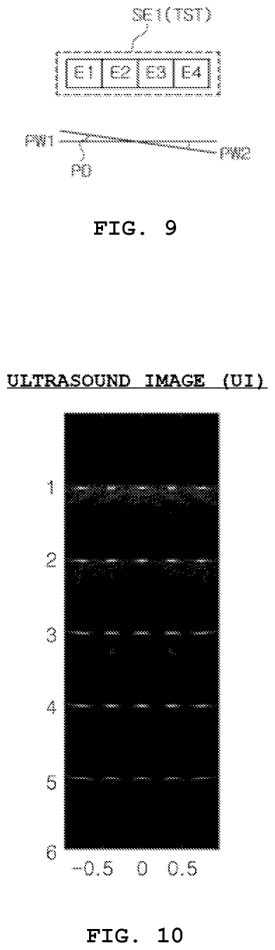

FIG. 8 is a view for explaining another operation example of the ultrasound transceiver included in the ultrasound device of FIG. 1; FIG. 9 is a view for explaining a plane wave formed by the ultrasound transceiver included in the ultrasound device of FIG. 1; and FIG. 10 is a view for explaining an ultrasound image generated based on a reception ultrasound signal received by an ultrasound transceiver included in the ultrasound device of FIG. 1.

Referring to FIGS. 1 through 10, in an embodiment, the reception sector RST selected based on the reception control signal RCS may remain the same while the ultrasound transceiver 200 sequentially changes the transmission sector TST selected based on the transmission control signal TCS to transmit the transmission ultrasound signal TUS N times, and the reception sector RST selected based on the reception control signal RCS may be changed after the transmission ultrasound signal TUS is transmitted N times. For example, the transmission sector TST selected based on the transmission control signal TCS may be the first sector element SE1, and the number of the plurality of sector elements may be four. In this case, the reception sector RST selected based on the reception control signal RCS may be fixed to the first sector element while the ultrasound transceiver 200 sequentially transmits the transmission ultrasound signal TUS by using the first sector element SE1 to the fourth sector element SE4, corresponding to the transmission sector TST. The reception sector RST selected based on the reception control signal RCS may be changed from the first sector element to the second sector element after the transmission ultrasound signals TUS is sequentially transmitted through the first sector element SE1 to the fourth sector element SE4, corresponding to the transmission sector TST. The transmission ultrasound signal TUS may be sequentially transmitted again using the first sector element SE1 to the fourth sector element SE4 after the reception sector RST is changed from the first sector element to the second sector element. In the same way, the ultrasound image may be implemented by synthesizing the reception ultrasound signal RUS received through the reception sector RST.

In an embodiment, the controller 100 may allow the transmission sector TST to be changed based on the control signal TCS after the ultrasound transceiver 200 transmits the transmission ultrasound signal TUS consecutively N times by using the transmission sector TST selected based on the transmission control signal TCS. For example, the transmission sector TST selected based on the transmission control signal TCS may be the first sector element SE1, and the number of the plurality of sector elements may be four. In this case, the transmission ultrasound signal TUS may be transmitted four times by using the first sector element SE1 corresponding to the transmission sector TST, and then, at the fifth time T5, the controller 100 may allow the transmission sector TST to be changed from the first sector element SE1 to the second sector element SE2 based on the transmission control signal TCS. The controller 100 may allow the transmission sector TST to be changed from the first sector element SE1 to the second sector element SE2 based on the transmission control signal TCS, and the ultrasound device 10 according to the present disclosure may then receive the reception ultrasound signal RUS while the reception sector RST selected based on the reception control signal RCS is sequentially changed from the first sector element SE1 to the fourth sector element SE4 whenever the transmission ultrasound signal TUS is transmitted through the second sector element SE2 corresponding to the transmission sector TST selected based on the transmission control signal TCS in the same manner as described in FIGS. 1 to 7.

In an embodiment, the transmission ultrasound signal TUS may be transmitted consecutively N times by using the changed sector element corresponding to the changed transmission sector TST. For example, the changed transmission sector TST may be the second sector element SE2 when the controller 100 allows the transmission sector TST to be changed from the first sector element SE1 to the second sector element SE2 based on the transmission control signal TCS, and the reception sector RST selected based on the reception control signal RCS may be sequentially changed whenever the ultrasound transceiver 200 transmits the transmission ultrasound signal TUS by using the changed transmission sector TST.

In an embodiment, the number of transmission sector TST and the number of reception sector RST, included in the ultrasound transceiver 200, may be the same as each other. For example, the plurality of sector elements may include the first sector element SE1, the second sector element SE2, the third sector element SE3 and the fourth sector element SE4. In this case, the transmission sector TST may be one of the first sector element SE1 to the fourth sector element SE4, and the reception sector RST may be one of the first sector element SE1 to the fourth sector element SE4. In addition, in an embodiment, the number of transmission sector TST and the number of reception sector RST, included in the ultrasound transceiver 200, may be different from each other.

In an embodiment, a plane wave PW may be formed based on the transmission ultrasound signal TUS provided from the ultrasound transceiver 200. In addition, the ultrasound device 10 may transmit the transmission ultrasound signal TUS while changing an angle of the plane wave PW. For example, the ultrasound device 10 may transmit the transmission ultrasound signal TUS to the object OJ while sequentially changing the angle of the plane wave PW transmitted from the ultrasound device 10 by adjusting time delay applied to the plurality of elements included in the ultrasound array.

The ultrasound device 10 according to the present disclosure may perform a transmission/reception operation by using the first sector element SE1 to the fourth sector element SE4 at a second plane wave angle PD2 after performing a transmission/reception sequence by using the first sector element SE1 to the fourth sector element SE4 at a first plane wave angle PD1. Such an operation may be repeatedly performed while the plane wave angle PD is changed, and an ultrasound image UI may be formed based on the reception ultrasound signal RUS received through the first sector element SE1 to the fourth element E4. In an embodiment, the ultrasound device 10 may form the ultrasound image UI by synthesizing the reception ultrasound signal RUS received through the reception sector RST.

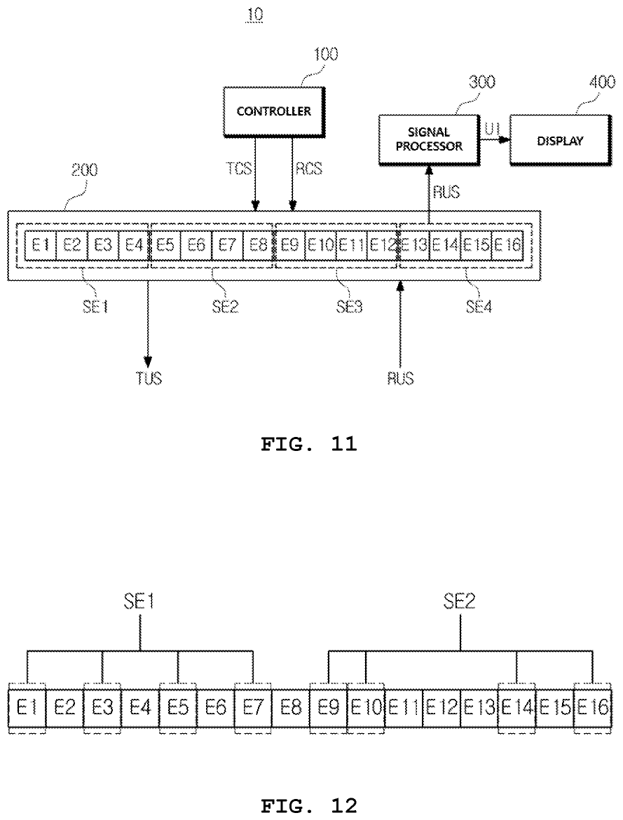

FIG. 11 is a view showing an ultrasound system according to embodiments of the present disclosure.

Referring to FIGS. 1 through 11, an ultrasound system according to another embodiment of the present disclosure may include a controller 100, an ultrasound transceiver 200, a signal processor 300 and a display 400. The controller 100 may classify a plurality of elements included in an ultrasound array into a plurality of sector elements, allow a transmission control signal TCS for selecting one of the plurality of sector elements as a transmission sector TST to be provided, and allow a reception control signal RCS for selecting one of the plurality of sector elements as a reception sector RST to be provided. The ultrasound transceiver 200 may select the transmission sector TST from the plurality of sector elements included in the ultrasound array based on the transmission control signal to transmit a transmission ultrasound signal TUS to an object OJ, and select the reception sector RST from the plurality of sector elements based on the reception control signal RCS to receive a reception ultrasound signal RUS reflected from the object OJ. The signal processor 300 may provide information on an ultrasound image UI by signal-processing the reception ultrasound signal RUS, and the display 400 may provide the ultrasound image based on the information on an ultrasound image UI.

In an embodiment, the reception sector selected based on the reception control signal may remain the same while the transmission sector selected by ultrasound transmission/reception control is changed and the transmission ultrasound signal is transmitted N times in case that the number of the plurality of transmission sector elements is N (here, N is a natural number greater than or equal to two). In addition, the controller may allow the reception sector to be changed based on the reception control signal after the ultrasound transceiver receives the reception ultrasound signal consecutively N times by using the reception sector selected based on the reception control signal.

In an embodiment, the changed reception sector may remain the same and be received consecutively N times while the transmission sector selected based on the ultrasound transmission/reception control is changed and the transmission ultrasound signal is transmitted N times. In addition, a plane wave may be formed based on the transmission ultrasound signal provided from the ultrasound transceiver, and the ultrasound device may transmit the transmission ultrasound signal while changing an angle of the plane wave.

In an embodiment, the ultrasound device may form the ultrasound image by synthesizing the reception ultrasound signal received through the reception sector. In addition, the reception sector selected based on the reception control signal may be changed while the ultrasound transceiver maintains the transmission sector selected based on the transmission control signal the same and transmits the transmission ultrasound signal N times, and the transmission sector selected based on the transmission control signal may be changed after the transmission ultrasound signal is transmitted N times.

In an embodiment, each of the transmission sector elements and reception sector elements may be a predetermined element selected from the plurality of elements.

The ultrasound system according to the present disclosure may have an improved image quality by selecting the transmission sector TST from the plurality of sector elements included in the ultrasound array based on the transmission control signal TCS to transmit the transmission ultrasound signal TUS to the object OJ, and by selecting the reception sector RST from the plurality of sector elements based on the reception control signal RCS to receive the reception ultrasound signal RUS reflected from the object OJ and then synthesizing the ultrasound image UI.

### Advantageous Effect

As set forth above, the present disclosure has the following effects.

The ultrasound device according to the present disclosure may have the improved image quality by transmitting the transmission ultrasound signal to the object by selecting the transmission sector from the plurality of sector elements included in the ultrasound array based on the transmission control signal, receiving the reception ultrasound signal reflected from the object by selecting the reception sector from the plurality of sector elements based on the reception control signal, and then synthesizing the ultrasound image.

In addition, other features and advantages of the present disclosure may be newly identified through the embodiments of the present disclosure.

1. An ultrasound device comprising:
a controller classifying a plurality of elements included in an ultrasound array into a plurality of transmission sector elements and a plurality of reception sector elements for transmission and reception, respectively, providing a transmission control signal for selecting one of the plurality of transmission sector elements as a transmission sector, and providing a reception control signal for selecting one of the plurality of reception sector elements as a reception sector; and
an ultrasound transceiver transmitting a transmission ultrasound signal to an object by selecting the transmission sector from the plurality of sector elements included in the ultrasound array based on the transmission control signal, and receiving a reception ultrasound signal reflected from the object by selecting the reception sector from the plurality of sector elements based on the reception control signal.

2. The ultrasound device of claim 1, wherein the reception sector selected based on the reception control signal remains the same while the transmission sector selected by ultrasound transmission/reception control is changed and the transmission ultrasound signal is transmitted N times in case that the number of the plurality of transmission sector elements is N (here, N is a natural number greater than or equal to two).

3. The ultrasound device of claim 2, wherein the controller allows the reception sector to be changed based on the reception control signal after the ultrasound transceiver receives the reception ultrasound signal consecutively N times by using the reception sector selected based on the reception control signal.

4. The ultrasound device of claim 3, wherein the changed reception sector remains the same and is received consecutively N times while the transmission sector selected based on the ultrasound transmission/reception control is changed and the transmission ultrasound signal is transmitted N times.

5. The ultrasound device of claim 4, wherein a plane wave is formed based on the transmission ultrasound signal provided from the ultrasound transceiver.

6. The ultrasound device of claim 5, wherein the ultrasound device transmits the transmission ultrasound signal while changing an angle of the plane wave.

7. The ultrasound device of claim 6, wherein the ultrasound device forms an ultrasound image by synthesizing the reception ultrasound signal received through the reception sector.

8. The ultrasound device of claim 1, wherein the reception sector selected based on the reception control signal is changed while the ultrasound transceiver maintains the transmission sector selected based on the transmission control signal the same and transmits the transmission ultrasound signal N times, and the transmission sector selected based on the transmission control signal is changed after the transmission ultrasound signal is transmitted N times.

9. The ultrasound device of claim 8, wherein a plane wave is formed based on the transmission ultrasound signal provided from the ultrasound transceiver.

10. The ultrasound device of claim 9, wherein the ultrasound device transmits the transmission ultrasound signal while changing an angle of the plane wave.

11. The ultrasound device of claim 10, wherein the ultrasound device forms an ultrasound image by synthesizing the reception ultrasound signal received through the reception sector.
